(19) United States
(12) Patent Application Publication
(10) Pub. No.: US 2008/0135614 A1
(43) Pub. Date: Jun. 12, 2008

(54) PASSIVE DETECTION OF ANALYTES

(75) Inventors: Douglas H. Werner, State College, PA (US); Theresa S. Mayer, Port Matilda, PA (US); Michael J. Roan, Blacksburg, VA (US)

Correspondence Address: GIFFORD, KRASS, SPRINKLE,ANDERSON & CITKOWSKI, P.C, PO BOX 7021, TROY, MI, 48007-7021, US

(73) Assignee: The Penn State Research Foundation, University Park, PA (US)

(21) Appl. No.: 11/769,991

(22) Filed: Jun. 28, 2007

Related U.S. Application Data
(60) Provisional application No. 60/817,896, filed on Jun. 30, 2006.

(51) Int. Cl. G06K 7/10

(52) U.S. Cl. 235/439

(57) ABSTRACT

An example apparatus for facilitating detection of an analyte comprises a substrate supporting an antenna circuit that includes an antenna and a sensing element. The sensing element has a property, such as electrical resistance, that is modified by an interaction between the analyte and the sensing element. The antenna circuit generates transmitted radiation when irradiated with incident radiation, acting as a transponder, and the transmitted radiation has a spectral distribution correlated with a property of the sensing element so as to facilitate detection of the analyte. In some examples, the antenna circuit may be supported by a personal data card, such as a passenger ticket for a public transport system.

### REFERENCE TO RELATED APPLICATION

This application claims priority from U.S. Provisional Patent Application Ser. No. 60/817,896, filed Jun. 30, 2006, the entire content of which is incorporated herein by reference.

### FIELD OF THE INVENTION

The present invention relates to the detection of analytes, in particular to the use of transponder devices such as RFID tags for the detection of analytes, such as chemical and/or biological materials.

### BACKGROUND OF THE INVENTION

Conventionally analyte sensors typically require an integrated power source. There is a need for passive sensor technologies, including analyte sensors that can be interrogated remotely.

### SUMMARY OF THE INVENTION

An example apparatus for facilitating detection of an analyte comprises a substrate supporting an antenna circuit, including an antenna and a sensing element. The sensing element has a property, such as electrical resistance, that is modified by an interaction between the analyte and the sensing element. The antenna circuit generates transmitted radiation when irradiated with incident radiation, so that the antenna circuit acts as a transponder, even in examples of the present invention where the antenna circuit has no dedicated power supply. The transmitted radiation has a spectral distribution correlated with the electrical resistance of the sensing element so as to facilitate detection of the analyte. For example, the presence of spectral harmonics may be used to remotely detect the presence of an analyte.

In some examples, the antenna circuit comprises a dipole pair comprising first and second dipole antenna elements, and the sensing element may be located between the first and second dipole antenna elements. The sensing element may comprise a chemoresistive material, a bioresistive material, or other material providing a property change (such as electrical resistance, permittivity, fluorescence, magnetic property, mechanical property, or other property) on exposure to the analyte. In some examples, the sensing element comprises a fluorescent material and a photoresistor, the analyte induces fluorescence quenching of the fluorescent material reflected in a change in photoresistor resistance. A fluorescent material and photoresistor may be formed as adjacent strips, in a multilayer film, and optical materials such as a waveguide may be used direct fluorescence to a photoresistor.

In other examples, the antenna comprises a coil having one or more loops of an electrical conductor, which may be part of a resonant circuit with at least one capacitor. An analyte sensing material, such as an analyte sensitive switch, may be operable on exposure to the analyte to switch an additional capacitor into or out of the resonant circuit so as to modify the resonant frequency. An analyte-sensing element may also be connected between the first and second dipole antenna elements of a dipole pair antenna.

In some examples, the sensing element is an analyte sensitive switch, having a first electrical resistance when the analyte is absent, and a second electrical resistance when the analyte is present, for example above a detection threshold. An analyte sensing switch, when opened or closed due to presence of the analyte, may modify the presence of harmonics in the field generated by the antenna circuit, modify a resonant frequency (if applicable), or otherwise modify the spectral properties of the transmitted radiation. A closed state of the analyte sensitive switch may be used to short out a component in the antenna circuit, effectively removing it from the antenna circuit, or to introduce one or more additional components into the antenna circuit. Additional component(s) may act to modify the resonant frequency of a resonant circuit within the antenna circuit.

The antenna circuit may be formed on a substrate, such as a thin rectangular sheet having the form factor of a driver's license, credit card, or ticket. The antenna circuit may be part of a personal data card adapted to be carried by a person, such as a ticket (such as an event entry ticket, public transport ticket such as a fare card, personal identification card (such as an employee or organizational identification card, drivers' license, library card, and the like), financial card (such as a credit card or other bank card), or other personal data card (such as a business card). A personal data card may include data related to the identity of the person, though this is optional. A personal data card may include data related to the rights of a person to use a facility or enter a building, transportation device, or event, such information possibly including a date, expiry date, entry point (e.g. station entered for a metro system), and the like. In particular, a personal data card may be an identity card, a credit card, and a ticket. The substrate may be a thin, substantially rectangular sheet, the substrate optionally further supporting a data storage device such as a magnetic data strip. The stored data may relate to the function as a personal data card, and may optionally include personal identity, or other data related to use of the personal data card. The substrate may be a wood or other fiber based product based, plastic, metal, or any other convenient form.

Hence, apparatus according to embodiments of the present invention include personal data cards such as those described herein, which may function e.g. both as a ticket (or other use) and also as portable analyte sensors. The term personal data card does not necessarily imply storage of personal data such as identity, though that is possible. The term personal data card, as used herein, includes items used for transport, such as subway tickets, that only include data such as fare paid, station entry, or other data relevant to use of the card.

The substrate may further support a magnetic data strip, so that an apparatus functions as a ticket or identification card, as well as an apparatus for facilitating analyte detection. A sensor apparatus comprising a substrate and an antenna circuit disposed on the substrate, the antenna circuit including an antenna and a sensing element, may be used with a remote apparatus, the remote apparatus being operable to produce incident radiation and to detect transmitted radiation from the sensor apparatus when the incident radiation is incident on the sensor apparatus, the antenna generating transmitted radiation when irradiated with incident radiation, and the transmitted radiation having a transmitted spectral distribution that is correlated with a property of the sensing element so as to facilitate detection of the analyte. The sensing element may have an electrical resistance that is modified by an interaction between the analyte and the sensing element. An example remote apparatus is operable to analyze the spectral distribution of the transmitted radiation so as to determine a presence of the analyte at the sensor apparatus.

Example apparatus may be used as hazard warnings for a person working in a hazardous area, for example a mine, hospital, chemical plant, and the like. The analyte sensitive element may be responsive to radioactivity, the analyte being radioactive. An interrogating apparatus may provide a warning if any apparatus indicates a presence of an analyte, if the analyte is hazardous. A warning may include flashing lights, synthesized or recorded speech, or other audible or visually discernable alerts. All interrogating device may have additional functionality, such as a personal identification card reader, for example taking data from the magnetic data strip.

A process for detecting an analyte in a public area comprises providing a person entering the public area with a personal data card (such as a ticket, for example a fare card), the personal data card comprising an antenna circuit including an analyte sensitive element. At least once, or at intervals, the personal data card is irradiated with electromagnetic radiation that forms incident radiation falling on the antenna circuit. Transmitted radiation transmitted by the antenna circuit while under irradiation by the incident radiation is detected and analyzed. The analyte may be detected using spectral properties of the transmitted radiation, such as the presence or absence of harmonics of the incident radiation, or other parameter related to the spectral distribution of the transmitted radiation, such as frequency, linewidth, relative amplitudes of two frequencies, and the like.

### BRIEF DESCRIPTION OF THE DRAWINGS

FIG. 1 shows a circuit schematic for an antenna circuit for a transponder such as an RFID tag;

FIGS. 2A and 2B illustrate implementation of an antenna circuit on a substrate, along with a magnetic data strip;

FIGS. 3A and 3B illustrate use of an analyte-sensitive (e.g. chemoresistive or bioresistive) switch in an antenna circuit parallel to a capacitive diode;

FIG. 4 shows an antenna circuit with an analyte-sensitive switch in a closed state, effectively eliminating a capacitive diode from the antenna circuit;

FIG. 5 shows an antenna circuit with an analyte-sensitive switch in an open state, so that the antenna circuit includes a capacitive diode;

FIG. 6 shows a configuration using inductive coupling; and

FIGS. 7A-7C illustrate conventional RFID tags, which may be adapted for use in embodiments of the present invention.

### DETAILED DESCRIPTION OF THE INVENTION

Embodiments of the present invention include the detection of analytes using transponder apparatus, such as radio frequency identification (RFID) tags including an analyte sensing element. Examples of the present invention include completely passive devices, which do not have a dedicated power source. Examples of the present invention can be easily adapted for use with existing infrastructure (such as existing RFID tag systems). RFID tag based analyte sensors can be readily concealed, if desired.

Transponder apparatus such as RFID tags are useful for product identification and other purposes, and may be interrogated remotely. However, in many situations it is useful to obtain further information from the apparatus location. Analyte sensing elements can be integrated into RFID tags to produce passive reconfigurable sensors (not requiring a dedicated power source) that can be used in conjunction with existing infrastructure for short and/or long range detection of analytes.

When an analyte is present, an analyte sensing element presents a change in property that modifies the electromagnetic response of the transponder. For example, a chemoresistive or bioresistive material may undergo a change in RE conductivity that interconnects or isolates parts of an antenna circuit. Upon interrogation with an RF signal, the antenna circuit produces a transmitted signal having parameters that can be used to confirm the presence or absence of an analyte. In some cases, the transmitted signal may include a signature that can uniquely identity the person or object carrying the REID tag.

A chemoresistive and/or bioresistive material can be used to modify an RFID tag. The modified REID tag can be custom designed to provide a unique response when exposed to a specific analyte or combination of analytes. A similar approach can be applied to any type of RFID tag scheme, including close range detection systems based on inductive coupling, and long-range detection systems, which employ resonant antenna elements.

Examples of the present invention include devices that do not have a dedicated power source. Energy from incident radiation induces transmission of the transmitted radiation. In other examples, capacitors or other charge storage devices may be used to store electrical charge. Examples of the present invention also include apparatus including a dedicated power source, such as a battery. A battery may be used to power circuitry such as a processor or memory, with the transmitted radiation being excited by incident radiation.

An example analyte sensing element (or “sensing element”) has at least one sensing property that is modifiable by the presence of an analyte. The sensing property may be an electrical property (such as resistance or permittivity), magnetic property (such as permeability), mechanical property (such as elastic constant), optical property (such as fluorescence, or transparency), or other property.

In some examples, the analyte sensing element acts as an analyte-sensitive switch. Examples include chemoresistive materials, which present a change in electrical resistance when a chemical analyte is present, and bioresistive materials, which present a change in electrical resistance when a biological analyte is present. Materials having an analyte-sensitive resistance may be used in a sensing element that acts as an analyte-sensitive switch, having a first resistive state in the absence of the analyte, and a second resistive state in the presence of the analyte (for example, above a threshold concentration). The resistance ratio of the first and second resistive states may be 10:1 or greater.

In other examples, an analyte sensitive switch comprises an analyte sensing material providing a sensing property change on exposure to the analyte, and a second material presenting an electrical resistance change in response to the sensing property change. For example, fluorescence from an analyte-sensing material may be incident on a photoresistor, the fluorescence being modified (e.g. quenched) by the analyte, resulting in a resistance change in the photoresistor.

An analyte sensitive switch may operate so as to switch one or more components (such as a capacitor, inductor, or resistor) in or out of the antenna circuit. The state of the analyte sensitive switch (open or closed, or even an intermediate state), and hence the presence or absence of the analyte, is then detectable by analysis of transmitted radiation induced by incident radiation (or interrogation radiation).

An analyte sensitive switch may include one or more semiconductor components such as a transistor, operational amplifier, and the like, the component being operational under incident radiation using power (voltage and current) derived from the incident radiation, for example using rectification and/or capacitive storage.

An analyte sensor may be located so as to be exposed to ambient atmosphere, such as outdoors, in a building, inside a public place such as a transportation hub, or inside or outside a vehicle. Analyte sensors may also be located so as to be exposed to liquids, such as water. Analyte sensors may also be located inside chemical processing facilities, other industrial sites, at various altitudes, or otherwise disposed.

Analytes that may be detected include chemical analytes and biological analytes. Chemical analytes include gases, such as air pollutants, such as nitrogen oxides, ozone, volatile organic compounds, and the like. Chemical analytes also include chemical process products for process monitoring, water contaminants, other air contaminants, chemical leak for leak detection, and other materials. Chemical analytes include hazardous materials such as explosives, and precursors, reagents, and products associated with hazardous materials. Biological analytes include microbes such as bacteria, including pathogens.

The antenna circuit and sensing element may be supported on a substrate. The substrate may have the form factor of a card (such as a personal data card such a business card, credit card, ticket, and the like), and be carried by a person. The card need not be wood-product based, as the substrate may be plastic, metal, or other material. A substrate may be laminated, for example with an analyte-permeable laminate or hole(s) allowing analyte access to the sensing element. Example personal data cards, which further act as substrates for an antenna circuit according to examples of the present invention include tickets (such as a public transport ticket, e.g. a bus ticket or subway ticket, parking ticket, airline ticket, or other ticket), identification card (such as drivers license, or organizational identification card), identification card holder, and the like. Other possible substrates for an antenna circuit include a clothing item (such as a hat, for example a tag attached to a clothing item), personal electronic device (such as a cell phone, music player, or computer), building structure (such as a wall or pole), portable item (such as a briefcase or suitcase), or other substrate.

There are a wide range of application areas where (passive) analyte sensors are useful. For illustrative purposes, an exemplary design of an RFID tag sensitive to the presence of a specific analyte within in a fare card of a mass transit system such as the subway or metro is described. Some or all of the sensor circuitry, such as the antenna circuit, may be concealed, for example within a paper or plastic ticket.

A long range RFID tag detection system can be used, with possible operating frequencies such as 915 MHz, 2.45 GHz, or 5.8 GHz, as used in conventional frequencies. However, other frequencies may be used.

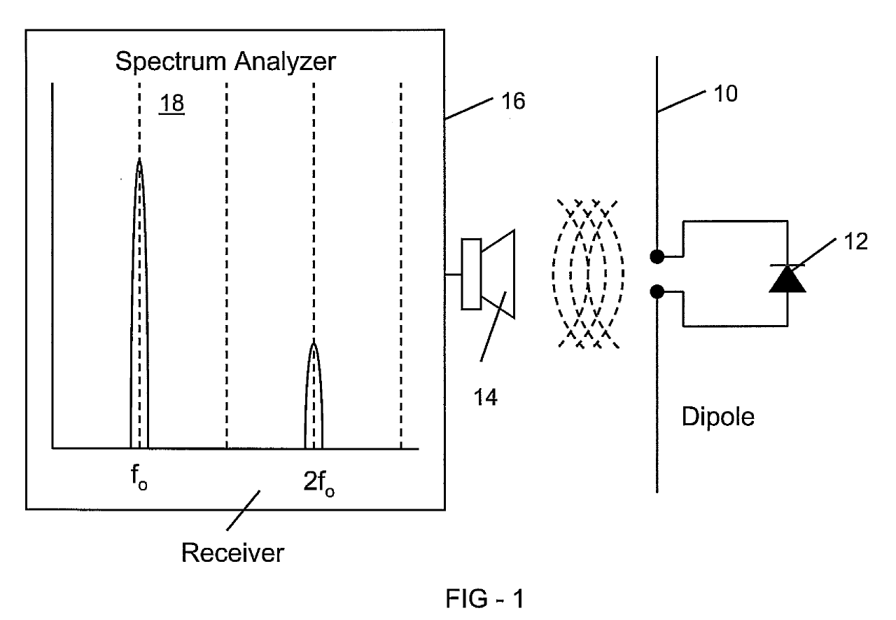

FIG. 1 shows a circuit schematic for a long range RFID tag antenna. The antenna circuit includes a dipole pair antenna, with two dipole elements such as 10, and a capacitive diode 12 connected between the dipole elements, here across the input terminals of the antenna. The non-linear properties of the capacitive diode cause the RFID tag antenna to transmit higher order harmonics of an incident electromagnetic signal, and the presence of these harmonics can easily be detected by a remotely located receiver 16. The remote apparatus 16 generates radiation incident on the dipole pair, and receives radiation transmitted from the dipole pair (shown as dashed arcs), and may be termed a transceiver or receiver.

The figure shows a spectrum analysis of radiation transmitted by the dipole pair, showing a component at the frequency of the incident radiation (f₀) and a component at the second harmonic (2f₀).

The signal strengths at the harmonic (and optionally the incident radiation frequency) can be determined using notch filters after detection and signal frequency downshifting. Other approaches can be used, as known in the radio arts.

In embodiments of the present invention, an analyte-sensitive clement, such as an analyte sensitive switch, is used to modify the spectral properties of the radiation transmitted by a transponder antenna upon irradiation by incident radiation. For example, radiation at the second or other harmonic of the incident radiation frequency may be indicative of the presence of an analyte.

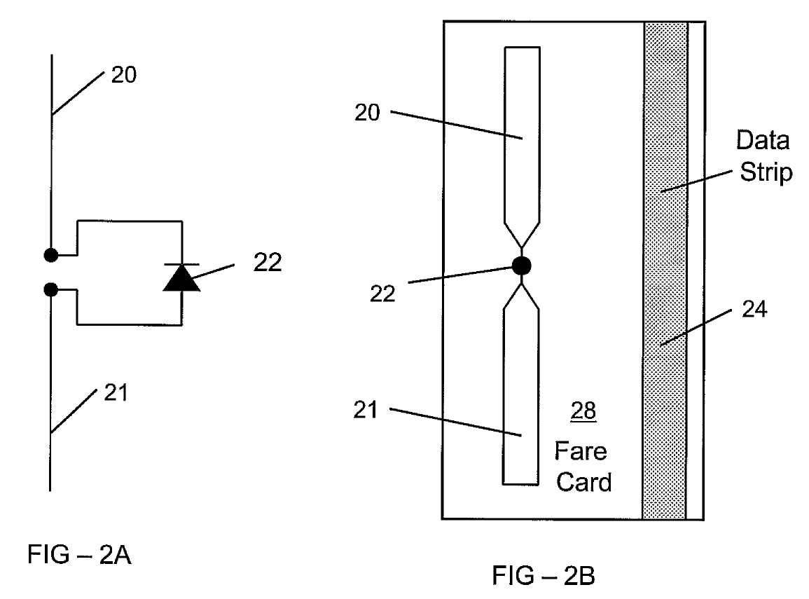

FIGS. 2A and 2B illustrate implementation on a substrate, in this case a ticket in the form of a public transportation fare card. FIG. 2B shows first and second dipole elements 20 and 21 formed on the substrate, interconnected by capacitive diode 22. A magnetic data strip is formed on the same substrate, and may be used to record entry point into a public transport system, fare paid, fare prepayment, or other data. FIG. 2A is the corresponding circuit diagram, which is the same as discussed above in relation to FIG. 1. However, examples of the present invention are not restricted to substrates as shown in this example.

The antenna circuit includes a dipole pair antenna, with the two dipole elements 20 and 21 formed as conductive regions on substrate 28. The capacitive diode 22 is also formed on the substrate. The antenna circuit may be concealed, for example between layers of a multilayer substrate.

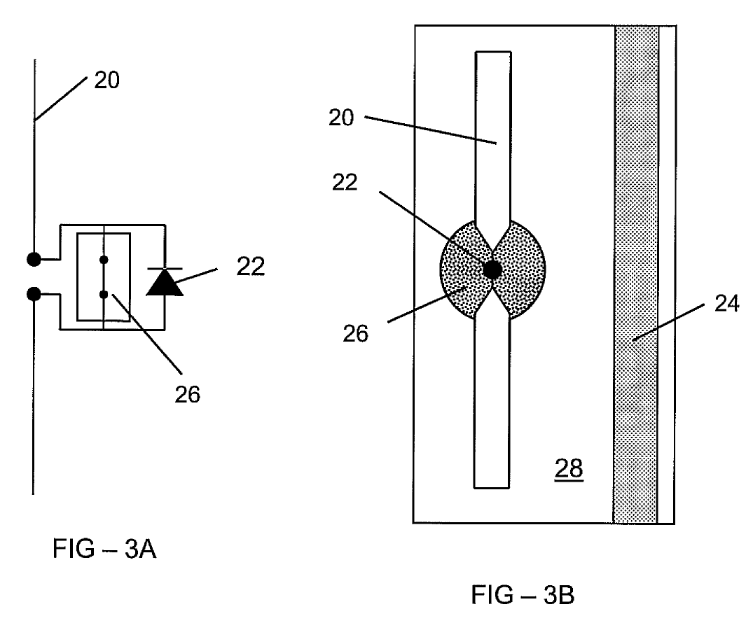

FIGS. 3A and 3B illustrate the introduction of an analyte-sensitive (e.g. chemoresistive or bioresistive) switch 26 into the antenna circuit, parallel with the capacitive diode. FIG. 3A shows a circuit schematic, and FIG. 3B shows an arrangement on a fare card substrate. Other elements are as discussed above in relation to FIGS. 2A and 2B. FIG. 3A shows a region of analyte-sensitive material 26 formed in a region between the dipole elements, so that when the region is electrically conducting it tends to electrically interconnect the dipole elements and short out the capacitive diode 22. FIG. 3A shows the analyte-sensitive switch as a closed switch, in which the capacitive diode is shorted out.

An analyte-sensitive switch may be designed to respond to the presence of one or more analytes. In this example, the switch is closed (in a higher electrical conductivity state at the operating frequency) when no analyte is present, so that the capacitive diode is essentially shorted out. Hence, there are no higher order harmonics in the spectrum of the signal backscattered by the RFID tag antenna. On the other hand, if exposed to an analyte, the switch is “open” (enter a lower electrical conductivity state). The diode would no longer be shorted out, and higher order harmonics are detectable in the spectrum of the backscattered signal. The higher order harmonics of the transmitted signal can be detected by a remotely located receiver.

In other examples, the analyte sensitive switch 26 shown in FIG. 3B may comprises a light emitting material (e.g. fluorescent material) and a photoresistor, for example as a multilayer structure, parallel stripes of material, or a composite.

In other examples, the area shown at 26 may be any analyte-sensitive element, in particular one exhibiting an electrical property change (e.g. resistance, capacitance, and/or inductance) in the presence of the analyte.

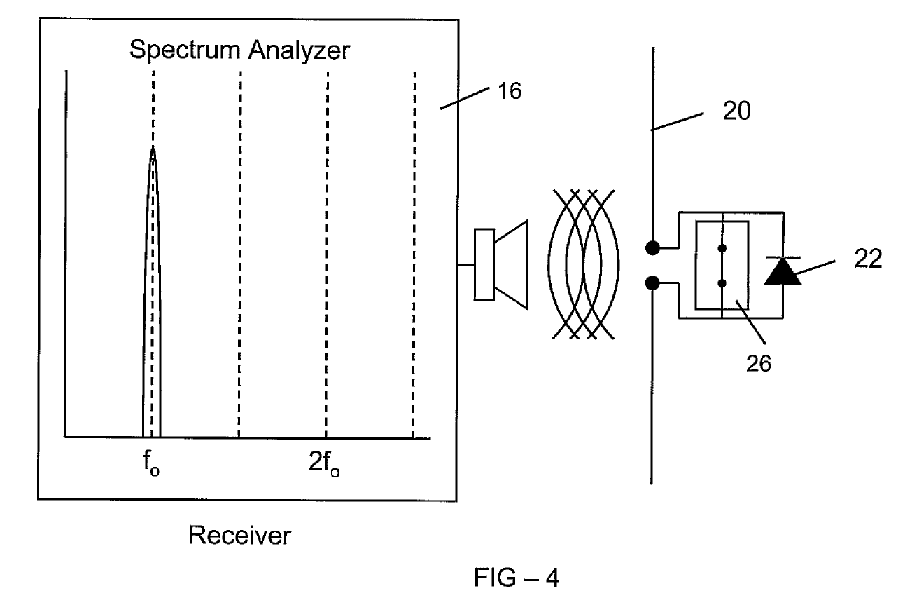

FIG. 4 shows the behavior of the antenna circuit with no analyte present. The analyte-sensitive switch 26 is closed, effectively eliminating the capacitive diode from the antenna circuit. Hence, the receiver circuit 16 does not detect harmonics in the radiation spectrum transmitted by the antenna (the antenna including a pair of dipole elements 20), as induced by radiation incident on the antenna.

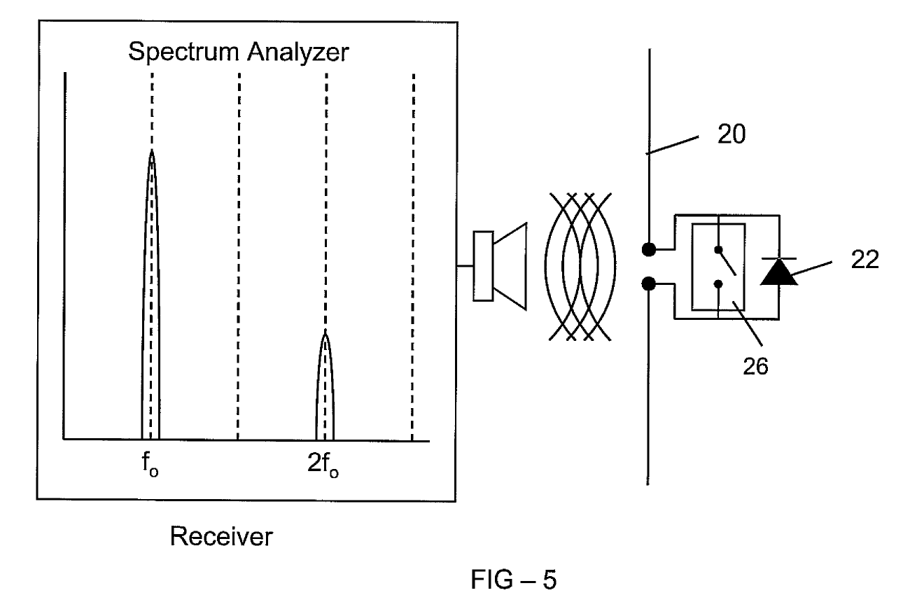

FIG. 5 shows the behavior of the antenna circuit with analyte present. In this example, the analyte-sensitive switch 26 is open, so that the antenna circuit includes the capacitive diode. Hence, the receiver circuit 16 detects harmonics in the radiation spectrum transmitted by the antenna (the antenna including a pair of dipole elements 20), as discussed above in relation to FIG. 1.

An RFID based analyte detection scheme may also use inductive coupling, typically a for close range interrogation. Passive analyte detection in a mass transit system is possible by including an analyte sensing element in a fare card. In this example, the RFID tag comprises an LC tuned circuit having a resonant frequency determined by capacitance and inductor values. One or more analyte-sensitive switches may be used to switch in additional capacitors and/or inductors on exposure to an analyte.

Detection of a plurality of analytes is possible, for example using first and second analyte-sensitive switches, which are associated with different values of capacitor. If the resonant frequency is determined, the presence of one or both of the analytes can be detected remotely.

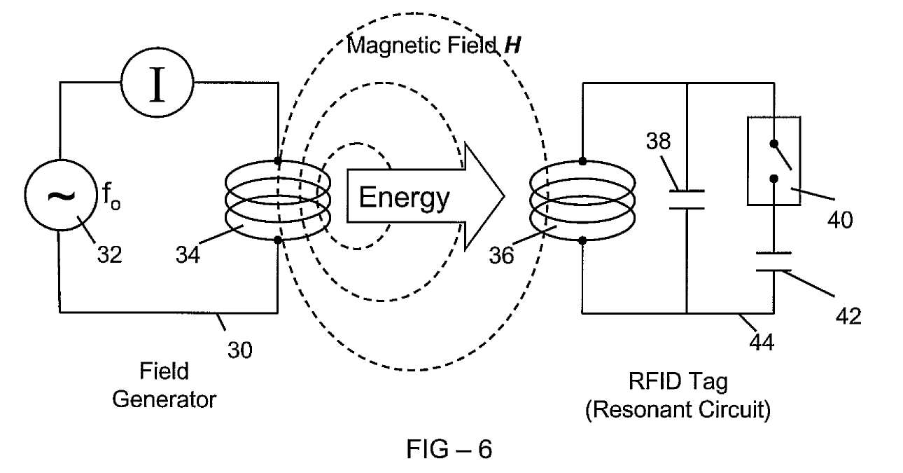

FIG. 6 shows a configuration using inductive coupling. Incident radiation is generated by coil 34 of field generator 30, excited at a frequency f₀ by excitation source 32. The generated electromagnetic field couples to antenna 36 (a multi-turn coil) through the magnetic field component (shown by dashed lines). The antenna coil forms a resonant circuit with capacitor 38. An analyte sensitive switch 40 placed in series with an additional capacitor 42 that can be connected in parallel with an LC tuned circuit. When the switch is “closed”, for example if no analyte is present, present, the equivalent circuit will resonate at a first resonant frequency. When an analyte is present, however, the switch “opens” and the resonant frequency shifts to a second resonant frequency due to the change in capacitance of the tuned circuit. The change in resonant frequency may be remotely detected.

In other examples, a capacitor, inductor, and/or resistor, or any combination thereof, may be switched in or out of a resonant circuit, so as to change resonance frequency and/or Q-factor, the change being detected as part of a method of sensing an analyte.

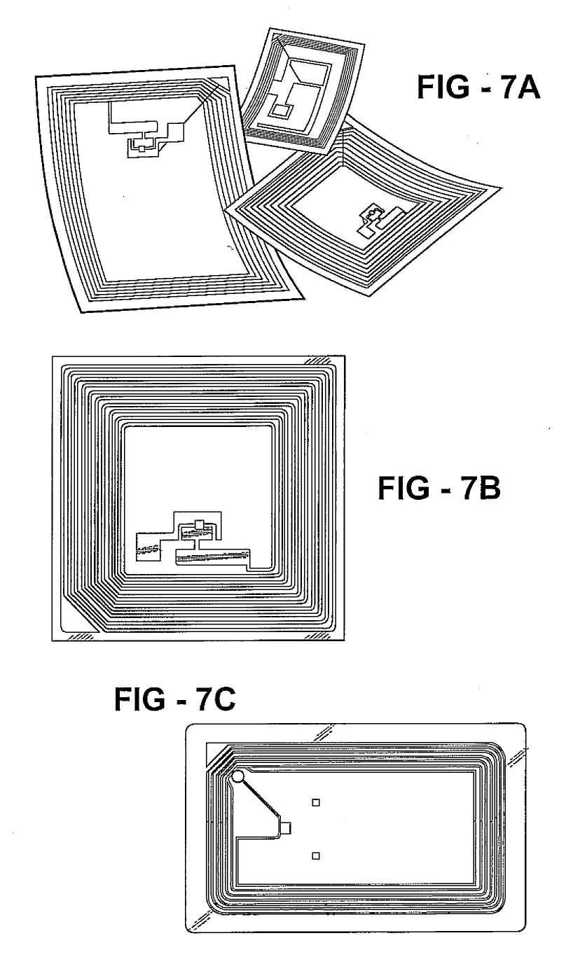

FIGS. 7A-7C illustrate conventional RFID tags used in various applications, which may be adapted for use in embodiments of the present invention. These examples are only intended for illustrative purposes.

Examples of the present invention also include advanced “smart cards” containing specialized microprocessor chips. For example, each chip could be designed to contain a different coded sequence that is unique to a particular tag, and can therefore be used for identifying and tracking of specific objects and/or individuals of interest. The chip may be powered by electrical energy derived from incident radiation.

In embodiments of the present invention, an analyte-sensitive material, such as a chemoresistive material, may be integrated into a circuit such as the circuit on an RFID tag, for example as analyte-sensitive reconfigurable electrical switches. When an analyte is present, the chemoresistive switches undergo a change in RF conductivity that connects or isolates parts of the electrical circuit, such as interconnecting or isolating antenna segments such as members of a dipole pair, or including or excluding components such as a capacitor, inductor, or resistor, or some combination thereof. Upon interrogation with an RF signal, the circuit produces a transmitted signal that can be used to confirm the presence or absence of a target analyte. The circuit may also produce a signature that can uniquely identify the object having the RFID tag, and identify the person having possession of the tag (if applicable).

Analyte sensitive materials and sensing elements formed therefrom may provide one or more detectable changes in properties on exposure to an analyte, for example changes in: electrical resistance, for example using a conducting polymer; other electrical properties such as permittivity, e.g. for a capacitive sensing element; optical properties such as transmission, reflectivity, or fluorescence; magnetic properties such as susceptibility; and the like. Associated components and/or circuitry may optionally be used to enhance the response, for example an electrical switch circuit triggered by a changing property of the material; a photoresistor influenced by an analyte-sensitive fluorescent material; optical interference effects; and the like.

Hence, an analyte-sensitive switch may comprise an analyte-sensitive material and associated components and/or electrical circuitry used to convert the analyte-induced change in the analyte-sensitive material to an appreciable change in electrical resistance. Many chemoresistive materials are known in the art, including chemoresistive polymers such as polythiophenes. Analyte sensitive materials may also include any chemoselective material having a property, such as resistance, that is modified by presence of a selected analyte.

In other approaches, an analyte-sensitive fluorescent material is located proximate a photoconductive material such as amorphous silicon, so as to induce a change in RF conductivity of the photoconductive material. A laser, other internal or external radiation source, or dedicated power supply, may optionally be used to excite the fluorescence. An optical filter may be used to reduce the effect of stray (non-fluorescence) light on the photoconductor. The analyte-sensitive switch may be covered (in whole or in part) with a vapor-permeable barrier layer. The analyte may induce fluorescence from the fluorescent material, or reduce fluorescence by a quenching mechanism. U.S. Pat. No. 6,558,626 to Aker et al. identifies fluorescent materials that may be used in embodiments of the present invention, including fluorescent polymers such as polyarylene ethynylenes, and non-polymeric materials such as fluorescein, rhodamine, anthracene, Texas Red, Cy3, green fluorescent protein and phycoerythrin. Numerous analyte-sensitive fluorescent materials are known in the chemical arts, which may be used in an analyte-sensitive switch.

A layer of analyte-sensitive material may be porous, for example to increase response speed by allowing an analyte to more rapidly reach the interior of the layer.

Analyte-sensitive materials include materials that change conductivity state in the presence of certain chemical or biological analytes, such as conductive polymers, including derivatives of polythiophenes, polypyrrole and polyaniline. The conductivity of such materials can be enhanced by building percolation threshold composites that include carbon black, nanowires and carbon nanotubes. A chemically sensitive field effect transistor (ChemFET) may also be used.

The analyte-sensitive switch may include a receptor layer for selectively binding analytes, such as biological or chemical receptors. The circuit may derive power from the interrogating RF or other ambient electromagnetic radiation to illuminate a fluorescent layer at intervals with exciting radiation, such as when interrogated.

Chemoresistive materials that can be used in embodiments of the present invention include organic semiconductors (organic or inorganic), semiconductor polymers, other polymers, metalorganics (such as phthalocyanines). Chemoresistive materials that can be used include those used in conventional chemoresistive gas sensors. Example materials that may be used in chemoresistive elements, possibly after functionalization, include: nanostructured materials such as metal or semiconductor nanowires, metal or semiconductor nanoparticles; forms of carbon such as nanotubes and fullerenes; polymers such as conducting polymers, including poly(acetylene), poly(pyrrole), poly(thiophene), polytbisthiophene phenylene), poly(aniline), poly(fluorene), poly(3-alkylthiophene), polynaphthalene, poly(p-phenylene sulfide), and poly(p-phenylene vinylene), polyphenylene, other polyarylenes, poly(arylene vinylene) such as polyphenylene vinylene), poly(arylene ethynylene)), other conjugated polymers, and the like, ladder polymers, macrocycles such as phthalocyanine and porphyrin, and polymers thereof, and the like.

Example chemoresistive materials include conducting polymers having an electrical conductivity modified by the presence of an analyte, for example decreasing when the conducting polymer is exposed to the analyte. Other example chemoresistive materials include nanostructured semiconductors, other nanostructured conductors such as metals, chemical field effect transistors, composites of a polymer and electrically conducting particles (such as polymers which swell in the presence of an analyte, and carbon-containing particles).

Typical chemoresistive conducting polymers can be used. A lower on-state conductivity may require a thicker layer of conducting polymer, such as tens of microns and thicker. The surface area of a chemoresistive film can be increased by surface topography (such as grooves), porous films, and the like, to increase surface area and sensitivity to an analyte. For example, porous conducting polymer films based on fabrics or fibers can be used.

Chemoresistive sensor switches preferably produce large changes in RF conductivity in response to analytes, while exhibiting low dielectric loss for the RF frequency bands of interest. Different physical mechanisms can be used, such as a chemically sensitive conducting polymer, a percolation threshold polymer/metal nanowire composite, or a chemically sensitive field effect transistor (ChemFET).

Examples of the present invention include chemically sensitive conducting polymers as chemoresistive elements in switches. Suitable polymers are disclosed in U.S. Pat. No. 6,323,309 to Swager et al. For example, the DC conduction pathway along a polymer backbone can be broken upon binding of an analyte, corresponding to a switch formed from the polymer conducting or on when a target analyte is not present and non-conducting or off when the target analyte is present. The RF properties of a chemoresistive polymer may not be identical to the DC properties, but operational devices are possible. The polymers may be also lossy, requiring a trade-off of sensitivity and other operational parameters.

The sensitivity of a device is correlated with the number of parallel-connected polymer wires. The sensitivity increases as the polymer film becomes very thin, i.e., a single conduction channel between electrodes can provide molecular level sensitivity.

Chemoresistive conducting polymer switches may show resistance changes that depend on the exposure concentration and time. Non-ideal concentration and time dependent resistance changes can be corrected by, for example, using a system modeling algorithm. Further, patterning processes used to fabricate chemoresistive polymer switches may modify the polymer properties.

Percolation threshold polymer/nanowire composites can also be used as a sensor switch. It is possible to achieve large changes in DC conductivity by incorporating carbon black within a nonconductive organic polymer matrix such that the carbon black forms an interconnected matrix at the percolation threshold for conduction (See for example U.S. Pat. No. 6,773,926, to Lewis and co-inventors, and Dai et al., Sensors and sensor arrays based on conjugated polymers and carbon nanotubes, Pure Appl. Chem., Vol. 74, No. 9, pp. 1753-1772, 2002). The organic polymer matrix undergoes a conformational change (i.e., swelling) in the presence of a particular analyte or class of analytes. The swelling causes the carbon black matrix to disconnect, which results in a significant drop in the de conductivity of the sensor.

Suitable nonconductive polymer matrices are known for a range of organic vapors, and more recently for several nerve agent simulants and explosives. Similar percolation threshold sensors that incorporate template synthesized gold metal nanowires should have improved RF properties (i.e., conductivity and loss) well suited for an apparatus according to the present invention.

For example, metal nanowires can be self assembled into dendritically connected networks using an external field applied directly to the patterned FSS prior to applying the nonconductive polymer across the entire RFSS. Although this switch requires a multi-step fabrication approach, it eliminates the need for patterning a chemically sensitive polymer. The resistance change of such percolation threshold sensors are expected to be more abrupt than the chemically sensitive chemoresistive polymers described previously. This type of non-ideal response can also be modeled to improve analytical accuracy.

Chemically sensitive field effect transistors can also be used as an RFSS sensor switch. Operation involves modulating the carrier density in nominally undoped silicon (or amorphous silicon; a-Si) through analyte binding, which induces a charge at the gate of the transistor. In conventional ChemFET technology, the channel resistance is modulated by changing the amount of inversion charge underneath the gate. Here, the introduction of carriers in the semiconductor will change the plasma frequency of the material and hence the RF conductivity of the material. In fact, this concept can be used for an improved RFSS design by optically exciting, for example using IR radiation, regions, such as masked regions, of a planar slab of intrinsic silicon. In this example, a FSS responsive to an external condition (IR radiation) is provided.

Various chemically sensitive gate materials can be used, including polymers and self-assembled monolayers with chemical recognition units.

Hence, an analyte sensor, to facilitate detection of an analyte, comprises an antenna formed from antenna segments, at least two antenna segments being connected by a sensing element comprising an analyte-sensitive material, such as an analyte-sensitive switch. In some examples, the antenna segments are electrically interconnected when the analyte sensitive switch is open, and less so when the switch is closed (and may be effectively electrically isolated from each other). The switch closed state corresponds to a lower electrical resistance of the switch, compared with the open state. Depending on the configuration, either the open or closed state may correspond to the presence of the analyte. The antenna may be a dipole antenna, with the analyte-sensitive switch interconnecting a pair of dipole segments. A crossed dipole antenna may also be used, or other antenna configuration. A system for detecting an analyte may comprise such an antenna combined with a remote RF interrogation system.

The use of remote RF interrogation permits interrogation of the tag, and hence analyte detection, through fabrics, walls, glass, bags, and the like. The analyte sensors can be interrogated using existing infrastructure such as RFID tag card and ticket readers. The sensors may be: small, e.g., credit card size or less; portable or part of a portable system, for example included in tickets, smart cards, or electronic devices; visually discernable, e.g. for IR, visible, or UV laser-interrogated systems; concealed, e.g. for security applications, for example in a ticket, freight-handling location, or passenger-handing location such as a station or airport; at a fixed location, for example as part of a sensor system network; or otherwise located. A substrate may further comprise an embedded chip (for example, the device being further operable as a smartcard) and contact surfaces for power and data interrogation. In some examples, a substrate may have dimensions of a typical credit card, typically approximately 86×54 mm, for example a width of 30 mm-60 mm and a length of 50 mm-120 mm. The substrate thickness may be in the range 0.5-5 mm. The substrate may further be used in a personal data card, such as a ticket.

Analytes which may be detected include volatile organics; air or water pollutants; components of any fluid mixture, for example for process control; biological materials including pathogens; explosive vapors and explosive residues; residues, derivatives, products, or precursors of any material of interest; and the like.

Applications include chemical process monitoring; pollutant monitoring; air and water cleanliness monitoring; and applications in public transport such as air, rail, road transport. Embodiments of the present invention include reconfigurable dipoles and their use in RFID and other uses.

Patents, patent applications, or publications mentioned in this specification are incorporated herein by reference to the same extent as if each individual document was specifically and individually indicated to be incorporated by reference.

The invention is not restricted to the illustrative examples described above. Examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

Having described our invention, we claim:

1. An apparatus for facilitating detection of an analyte, the apparatus comprising:
a substrate; and
an antenna circuit disposed on the substrate, the antenna circuit including an antenna and a sensing element,
the sensing element having an electrical resistance that is modified by an interaction between the analyte and the sensing element,
the antenna generating transmitted radiation when irradiated with incident radiation,
the transmitted radiation having a transmitted spectral distribution, the transmitted spectral distribution being correlated with the electrical resistance of the sensing element so as to facilitate detection of the analyte.

2. The apparatus of claim 1, wherein the apparatus is a personal data card adapted to be carried by a person.

3. The apparatus of claim 2, the personal data card being selected from a group of personal data cards consisting of an identity card, a credit card, and a ticket.

4. The apparatus of claim 2, the apparatus having no dedicated power supply, the transmitted radiation being powered by the incident radiation.

5. The apparatus of claim 2, wherein the substrate is a thin, substantially rectangular sheet, the substrate further supporting a magnetic data strip.

6 The apparatus of claim 1, wherein the antenna circuit comprises a dipole pair comprising first and second dipole antenna elements, the sensing element being located between the first and second dipole antenna elements.

7. The apparatus of claim 1, wherein the sensing element is a chemoresistive material.

8. The apparatus of claim 1, wherein the sensing element is a bioresistive material.

9. The apparatus of claim 1, wherein the sensing element is a fluorescent material and a photoresistor,
fluorescence from the fluorescent material being incident on the photoresistor,
wherein the analyte induces fluorescence quenching of the fluorescent material, the electrical resistance being a photoresistor resistance and being modified by the fluorescence quenching.

10. The apparatus of claim 1, wherein the sensing element is an analyte sensitive switch,
the analyte sensing switch having a first electrical resistance when the analyte is absent, and a second electrical resistance when the analyte is present above a detection threshold.

11. The apparatus of claim 10 wherein the antenna circuit comprises a resonant circuit having a resonant frequency
the analyte sensing switch modifying the resonant frequency.

12. The apparatus of claim 11, wherein the antenna comprises one or more loops of an electrical conductor,
the resonant circuit comprising the antenna and at least one capacitor.

13. The apparatus of claim 11, wherein the analyte sensing switch is operable to switch an additional capacitor into or out of the resonant circuit.

14. The apparatus of claim 10, wherein the antenna circuit comprises a dipole pair comprising first and second dipole antenna elements,
the analyte sensing switch being connected between the first and second dipole antenna elements.

15. The apparatus of claim 14, further comprising a diode capacitor electrically interconnecting the first and second dipole antenna elements.

16. An apparatus for facilitating detection of an analyte, the apparatus comprising:
a sensor apparatus, the sensor apparatus comprising:
a substrate; and
an antenna circuit disposed on the substrate, the antenna circuit including an antenna and a sensing element,
the sensing element having an electrical resistance that is modified by an interaction between the analyte and the sensing element; and
a remote apparatus, the remote apparatus operable to produce incident radiation and to detect transmitted radiation from the sensor apparatus when the incident radiation is incident on the sensor apparatus,
the antenna generating transmitted radiation when irradiated with incident radiation,
the transmitted radiation having a transmitted spectral distribution, the transmitted spectral distribution being correlated with the electrical resistance of the sensing element so as to facilitate detection of the analyte,
the remote apparatus being operable to analyze the spectral distribution of the transmitted radiation so as to determine a presence of the analyte at the sensor apparatus,
the sensing apparatus having no dedicated power supply.

17. The apparatus of claim 16, wherein the sensing element is an analyte sensitive switch,
the analyte sensing switch having a first electrical resistance when the analyte is absent, and a second electrical resistance when the analyte is present above a detection threshold,
the analyte sensing switch having a closed state and an open state,
the first or second electrical resistance corresponding to a closed switch state.

18. The apparatus of claim 17, wherein the sensor apparatus is further operable as a personal data card,
the substrate being a thin, substantially rectangular sheet,
the substrate further supporting a magnetic data strip.

19. The apparatus of claim 17, wherein the closed state of the analyte sensitive switch is used to short out a component in the antenna circuit.

20. The apparatus of claim 17, wherein the closed state of the analyte sensitive switch is used to introduce an additional component into the antenna circuit.

21. The apparatus of claim 17, wherein the antenna circuit includes a resonant circuit having a resonant frequency, the additional component acting to modify the resonant frequency of the resonant circuit.

22. A method of detecting an analyte in a public area, the method comprising:
providing a person entering the public area with a personal data card, the personal data card comprising an antenna circuit including an analyte sensitive element;
irradiating the ticket with electromagnetic radiation, the electromagnetic radiation being incident radiation falling on the antenna circuit;
detecting transmitted radiation transmitted by the antenna circuit when irradiated by the incident radiation;
detecting the analyte using spectral properties of the transmitted radiation.
